(19) United States
(12) Patent Application Publication
(10) Pub. No.: US 2009/0053594 A1
(43) Pub. Date: Feb. 26, 2009

(54) RECHARGEABLE AIR BATTERY AND MANUFACTURING METHOD

(76) Inventors: Lonnie G. Johnson, Atlanta, GA (US); Prabhakar A. Tamirisa, Atlanta, GA (US); Ji-Guang Zhang, Richland, WA (US)

Correspondence Address: BAKER, DONELSON, BEARMAN, CALDWELL & BERKOWITZ;Intellectual Property Department, Monarch Plaza, Suite 1600, 3414 Peachtree Rd., ATLANTA, GA, 30326, US

(21) Appl. No.: 11/843,814

(22) Filed: Aug. 23, 2007

(51) Int. Cl. H01M 2/02

(52) U.S. Cl. 429/163

(57) ABSTRACT

An air battery having an air cathode having a porous carbon based air cathode containing a non-aqueous organic solvent based electrolyte including a lithium salt and an alkylene carbonage additive. The battery also includes a separator loaded with an organic solvent based electrolyte including a lithium salt and an alkylene carbonate additive, a cathode current collector, an anode, an anode current collector, and a housing. The housing contains the cathode, separator, cathode current collector, anode, anode current collector, and a supply of air.

### TECHNICAL FIELD

This invention relates generally to batteries, and more particularly to air cathode type batteries.

### BACKGROUND OF THE INVENTION

Lithium-air batteries consist of lithium anodes electrochemically coupled to atmospheric oxygen through an air cathode. Oxygen gas introduced into the battery through an air cathode is essentially an unlimited cathode reactant source. These batteries have a very high specific energy and a relatively flat discharge voltage profile. A problem with present air batteries is their limited rechargeability.

It would be beneficial to provide an lithium-air battery that is rechargeable and easier to manufacture than those of the prior air. Accordingly, it is to the provision of such that the present invention is primarily directed.

### SUMMARY OF THE INVENTION

In a preferred form of the invention an air battery comprising an air cathode having a porous carbon based air cathode containing a non-aqueous organic solvent based electrolyte including a lithium salt and an alkylene carbonage additive. The battery also includes a separator loaded with an organic solvent based electrolyte including a lithium salt and an alkylene carbonate additive, a cathode current collector, an anode, an anode current collector, and a housing. The housing contains the cathode, separator, cathode current collector, anode, anode current collector, and a supply of air.

### BRIEF DESCRIPTION OF THE DRAWINGS

FIG. 1(a) is a schematic diagram of an air battery embodying principles of the invention in a preferred form.

FIG. 1(b) is a schematic diagram of an air battery embodying principles of the invention in another preferred form.

FIG. 1(c) is a schematic diagram of an air battery embodying principles of the invention in yet another preferred form.

FIG. 2 is a schematic diagram of a double cell structure.

FIG. 3(a)3(c) are a series of sequential views of the battery manufacturing method.

FIG. 4 is a chart showing the charge/discharge behavior of the air battery of the present invention.

FIG. 5 is a chart showing the charge/discharge cycling of the air battery of the present invention.

FIG. 6 is a chart showing the cycling stability of the air battery of the present invention.

FIG. 7 is a chart showing the voltage/current profile of the air battery of the present invention.

FIG. 8 is a chart showing the cyclability of the air battery of the present invention.

FIG. 9 is a chart showing the cycling stability of the air battery of the present invention.

FIG. 10 is a chart showing the cyclic voltammetry of the air battery of the present invention.

FIG. 11 is a chart showing the cyclic voltammetry of the air battery of the present invention.

FIG. 12 is a chart showing the cyclic voltametry of the air battery of the present invention.

FIG. 13 is a chart showing the voltage/current profiles and cycling stability of the air battery of the present invention.

FIG. 14 is a chart showing the voltage/current profiles of the air battery of the present invention.

FIG. 15 is a chart showing the cycling behavior of the air battery of the present invention.

FIG. 16 is a chart showing the cycling stability of the air battery of the present invention.

FIG. 17 is a chart showing the voltage/current profiles of the air battery of the present invention.

FIG. 18 is a chart showing the cycle stability of the air battery of the present invention.

FIG. 19 is a chart showing the voltage/current profiles and cycling behavior of the air battery of the present invention.

### DETAILED DESCRIPTION

With reference next to the drawings, there is shown in a battery or electrochemical cell 10 and method of producing such embodying principles of the invention in a preferred form. The cell 10 includes an air cathode 11, a cathode current collector 12, a separator 13, an anode 14, and an anode current collector 15.

To produce the cell 10 a Teflon bonded, Calgon carbon (activated carbon) based air cathode 11 is prepared by first wetting 14.22 g of Calgon carbon, 0.56 g of Acetylene black, and 0.38 g of electrolytic manganese dioxide by a 60 ml mixture of Isopropanol and water (1:2 weight ratio). The electrolytic manganese dioxide is an oxygen reduction catalyst, preferably provided in a concentration of 1% to 30% by weight. Alternatives to the electrolytic manganese dioxide are ruthenium oxide, silver, platinum and iridium. Next, 2.92 g of Teflon 30 (60% Teflon emulsion in water) is added to the above mixture, mixed, and placed in a bottle with ceramic balls to mix overnight on the rollers. After mixing, the slurry/paste is dried in an oven at 110° C. for at least 6 hours to evaporate the water, and obtain a dry, fibrous mixture. The dry mixture is then once again wetted by a small quantity of water to form a thick paste, which is then spread over a clean glass plate. The mixture is kneaded to the desired thickness as it drys on the glass plate. After drying, it is cold pressed on an Adcote coated Aluminum mesh at 4000 psi for 3 minutes. To remove any cracks in the paste, the cathode assembly is passed through stainless steel rollers. The cathode is then cut into smaller pieces such that the active area of the cathode is 2″ by 2″. A small portion of the aluminum mesh is exposed so that it may be used as the current collector tab.

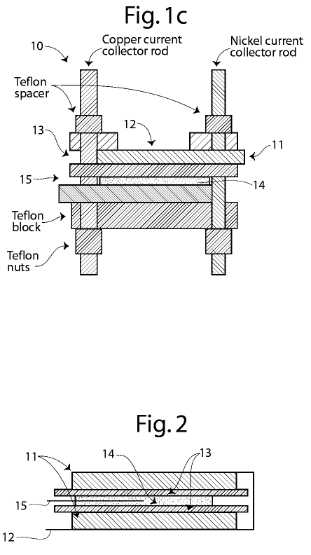

The cell assembly is performed inside of an argon filled glove box. The cathode is wet by a non-aqueous organic solvent based electrolyte including a lithium salt and an alkylene carbonate additive. The electrolyte may be lithium hexaflouraphosphate (1 M LiPF₆ in PC:DME). A pressure sensitive porous polymeric separator membrane (Policell, type B38) is placed on the cathode, with the shiny side facing away from the cathode. Next, a thin Li foil is placed on the wet separator, and a 1.5 cm×4 cm strip of copper mesh is placed along one edge, away from the aluminum mesh tab. Another cathode piece wet by the electrolyte and covered with the separator is placed directly on top of the lithium foil, and copper mesh strip. The double cell structure is shown in FIG. 2. This assembly is laminated on a hot press at 100° C., and 500 lb for 30-40 seconds. After the sample is withdrawn from the press, the heat activated separator binds the sample together. It should be understood that the separator is loaded with an organic solvent based electrolyte including a lithium salt and an alkylene carbonate such as vinylene carbonate or butylene carbonate.

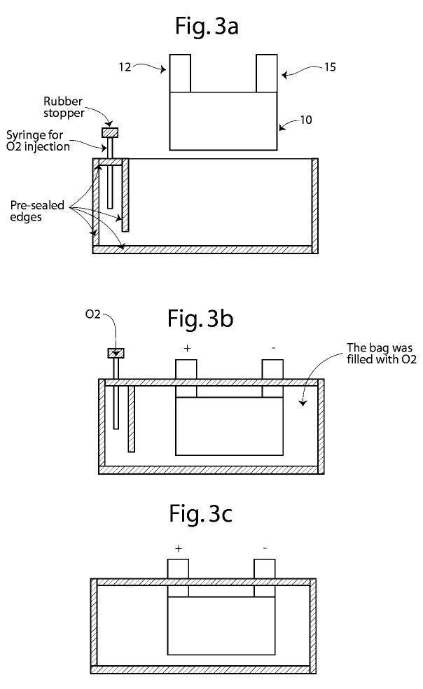

A bag made of multilayer polymer/metal lamination is pre-sealed on three sides, and has one side partially open as shown in FIG. 3(a). On the fourth, partially open side, a syringe needle is sealed into the bag. The top of the needle is sealed with epoxy. In addition, a partial seam is created along the length of the needle so the bag can be easily sealed. After ensuring that the cathode is not peeling from the separator, the assembly is soaked in the electrolyte for at least 5-10 minutes, and then inserted into the pre-assembled ‘blue bag’ pouch and sealed across the current collector mesh tabs (see FIG. 3(b). The pouch battery is then removed from the glove box and a syringe is used to inject oxygen through an epoxy filled fine tube. After injecting oxygen, the pouch is sealed once again, closer to the electrode assembly, using an impulse sealer, and the syringe-containing portion of the blue bag is trimmed, as shown in FIG. 3(c).

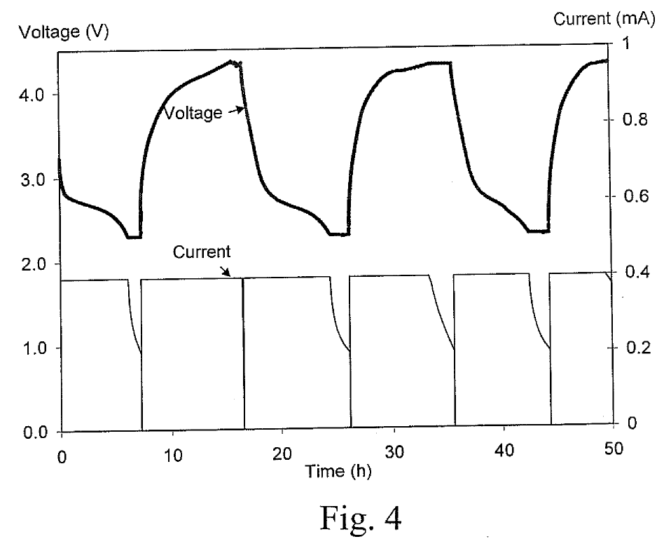

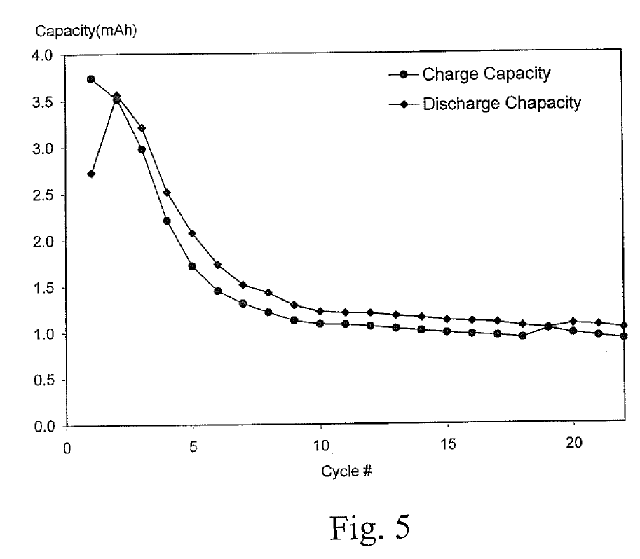

Previous reports showed reversibility of Li/O₂ battery only up to 3-4 cycles at low current densities. In a recently published paper, Ogasawara et al, J. Am. Chem. Soc. Vol. 128, 1390 (2006) reported that Li₂O₂ can be electrochemically decomposed to lithium and O₂ by charging to 4.5 V. However, no distinction was made between Li₂O₂ and Li₂O, and no information was provided on the reversibility of Li₂O. To decompose Li₂O₂ formed during the discharge cycle, it is necessary to charge the cell to >4 V vs. Li⁺/Li. Indeed, charge capacity of the Li/O₂ cells at a voltage ≦3.9 V vs. Li⁺/Li was very limited. Several experiments were conducted to check for reversibility when cells were charged to >4.0 V vs. Li⁺/Li. When the cells were charged to >4.0 V, significant amounts of mossy lithium metal deposits were found on the anode at the end of almost all experiments, suggesting that lithium metal is being plated on the anode during charging. In the first experiment, a carbon cathode (72.6% Calgon carbon/3% carbon black/4.4% MnO₂, 20% Teflon) with nickel mesh current collector was used in a cell consisting of a lithium metal foil as anode, and 1 M LiPF₆ in EC:DEC (1:1) as electrolyte. The cell was discharged to 2.3 V at 0.4 mA/cm², and charged to 4.3 V at the same current density; charge and discharge were terminated when the current reached 0.2 mA/cm² at constant voltage (FIG. 4). After three cycles, the width of the discharge plateau decreased, and the cell capacity dropped to ˜1 mAh (FIG. 5). Reducing the low voltage limit from 2.3 V to 2 V during the last cycle resulted in a large increase in the battery capacity, but this increased capacity diminished in the next cycle.

The effect of cathode additive (lithium peroxide, lithium oxide, or lithium superoxide) (Li₂O₂ or Li₂O) on Li/O₂ batteries has been investigated extensively. The composition of a typical Li₂O₂ containing cathode with the weight ratios of the various components in the cathode are as the following: Calgon carbon (71.1%), Li₂O₂ (14%), electrolytic MnO₂ (EMD) (1.9%), Kynar (10.2%), and carbon black (2.8%). First, 0.8 g of Kynar® (Elf Atochem North America, Inc.) was heat-dissolved (at 50° C.) in 20 ml acetone with active stirring, and then 5.6 g of carbon powder (Calgon, PWA), 1.1 g of Li₂O₂, 0.15 g of electrolytic manganese dioxide (EMD) (catalyst), and 0.22 g of carbon black were added and stirred overnight. The gel-like paste was cast on glass and acetone was allowed to evaporate. The thickness of the cast was ˜0.2 mm. The cast film (before it is fully dried) was placed on nickel mesh (cleaned in 5% NaOH for 30 seconds, washed by isopropyl and then dried in 80° C. oven) and laminated between two Kapton sheets using a stainless roller. Finally, the sample was dried in an 80° C. oven overnight. The final thickness of the air electrode was ˜0.1 mm thick. The sample area was 1 cm². The unit weight (g/cm²) of mesh and sample/mesh were weighed to calculate the sample weight. Alternatively, the gel-like paste may be cast directly on expanded metal mesh, and calendared.

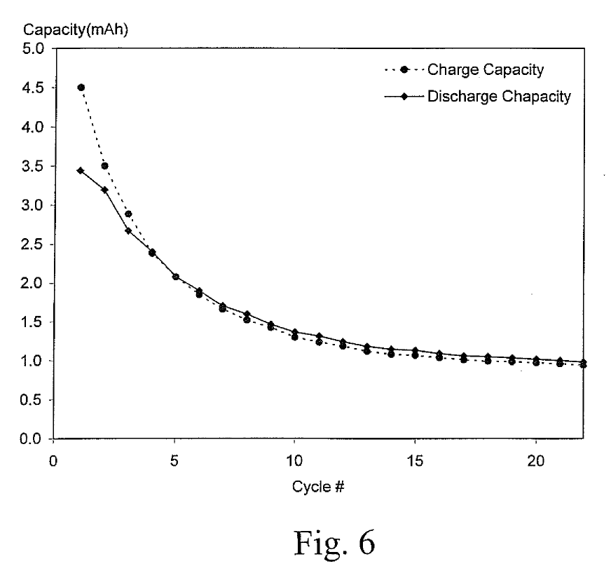

Charge/discharge cycles were performed at constant current of 0.5 mA/cm² between 4.5 V and 2.3 V; the cut off current during constant voltage charge/discharge was 0.1 mA/cm². The charge/discharge profile and cycling capacity of the cell is shown in FIG. 6. One of the reasons for the cycle fade may be the formation of discharge products such as Li₂O which may not be decomposed during the charge process. In fact, Read (Journal of The Electrochemical Society, 149-9, A1190, 2002) reported that 67% of the discharge product was Li₂O₂, the rest was Li₂O when the same electrolyte (1 M LiPF₆ in PC) was used. Apparently, a better electrolyte is required to produce more reversible Li₂O₂ as the discharge product.

Ogasawara et al. indicated that it is possible to decompose Li₂O₂ by charging to more than 4.3 V in a PC-based electrolyte. On the other hand, there is no concrete evidence to demonstrate the reversibility of Li₂O. Therefore, to insure the rechargeability of Li/O₂ battery, it is prudent to preferentially form Li₂O₂ (instead of Li₂O) during discharge process. Read indicated that composition of the discharge by-product strongly depends on the selection of electrolyte. Table 2 lists the percentage of Li₂O₂ and Li₂O formed during the discharge process when different electrolyte is used in Li/O₂ cells. The table indicates that 1M LiPF₆ in PC:DME (1:1) or 1 M LiPF₆ in PC:THF (1:1) are good candidates because these electrolytes lead to almost 100% production of Li₂O₂ instead of Li₂O in the discharge process.

In addition to electrolyte formulation, lower discharge rates, and higher oxygen concentrations in the electrolyte also favored the formation of Li₂O₂ instead of Li₂O. Furthermore, oxygen concentration in the electrolyte is determined by the solubility of oxygen in the electrolyte. Since ether based solvents have the highest oxygen solubilities among the organic solvents used in lithium batteries, low discharge rates in ether-based solvents are likely to form Li₂O₂ preferentially. This is consistent with the preferential formation of Li₂O₂ in PC:DME and PC:THF electrolyte as shown in Table 2. Since higher charge voltages are likely to completely charge the cell, and EC:DEC electrolyte itself may decompose when charged to >4.3 V, initially, a different cell using 1 M LiPF₆ in PC was used to access the higher voltages. In this cell, a Li₂O₂ containing cathode was used in conjunction with a lithium metal foil anode.

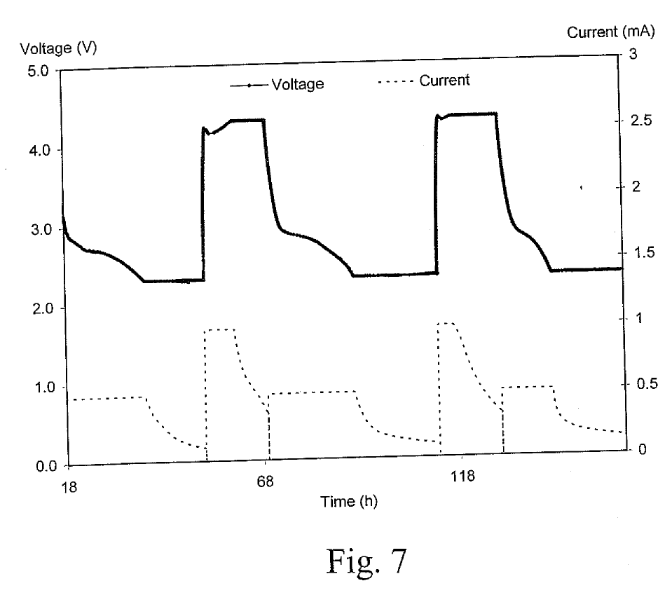

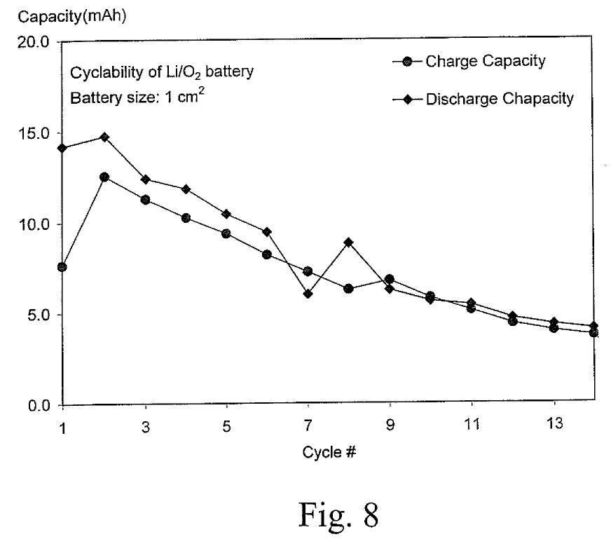

Several cells with ether-based solvents have been prepared. The cells tested in electrolyte containing THF is unstable at higher voltages (>4V). Read showed that 97% of the discharge products in Li/O₂ cells using PC:DME based electrolyte was Li₂O₂. Therefore, this electrolyte has been used in the subsequent investigation. FIG. 7 shows the charge/discharge profiles of a Li/O₂ cell with a carbon cathode containing 14% Li₂O₂, a lithium metal foil anode, and 1 M LiPF₆ in PC:DME (1:2) as the electrolyte. The discharge capacity of the cell increased to more than 14 mAh which is much higher than the sample with no Li₂O₂ premixed in cathode. The cell also demonstrates significant rechargeability as shown in FIG. 8. The capacity fade is 5.4%/cycle during the first 15 cycles.

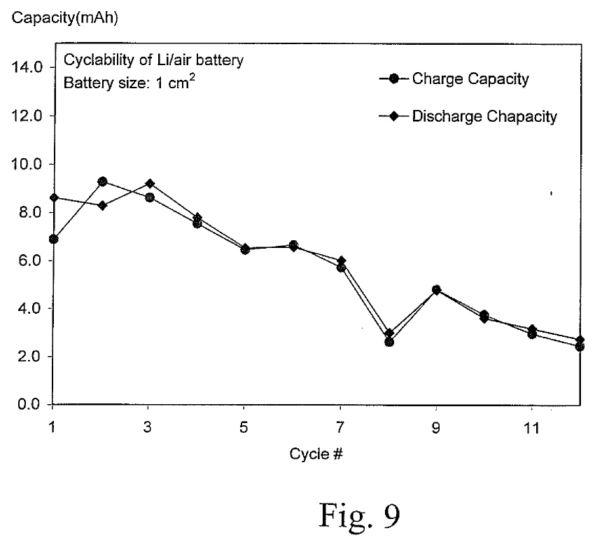

To examine the effect of the calendaring, another cathode was prepared by injecting the diluted cathode slurry into the cathode space confined by a Teflon holder. The cathode consists of a slurry of Calgon carbon, carbon black, Li₂O₂, and Electrolytic MnO₂, but it did not contain any binder (usually Kynar). The cathode was not calendared before use. Two drops of the powders mixed in the electrolyte (PC:DME (1:2)) were placed on an Al mesh current collector, and the cell was subjected to charge/discharge cycling. The sample was cycled between 2.3 to 4.3V. Cycling stability of this Li/O₂ cell are shown in FIG. 9. While the second cell with the liquid slurry cathode seemed to perform well in the first few cycles with relatively less capacity fade, the fade increased in the latter cycles, which also resulted in the loss of the characteristic discharge profiles with two inflection points. After 13 cycles, both cells show the similar capacity fade (˜5.4%/cycle).

While the progress in developing reversible Li/O₂ batteries has been encouraging, several issues remain to be solved. One of the main concerns is on the origin of the rechargeability. Although Ogasawara verified the decomposition of Li₂O₂ (during charge process) by mass spectrometry, other mechanisms may also contribute to the charge capacity. These mechanisms include decomposition of electrolyte (which is strongly affected by solvent, cathode, catalyst, and current collector) and other side effects. The capacity fade during cycling is also directly related to the charging mechanism.

As we can see from the test data shown in this report, the discharge plateau shrinks with increasing number of cycles, suggesting that the cell reactions may not be completely reversed during charging after prolonged cycling. One of the major reasons for this behavior may be the formation of small amounts of Li₂O during discharge, which, unlike Li₂O₂, may not be easily decomposed during charging. As the “irreversible” Li₂O formed in each discharge blocks the pores of the carbon cathode during discharge, the capacity of the carbon cathode for subsequent discharge cycles is reduced; hence some capacity fade may be inevitable.

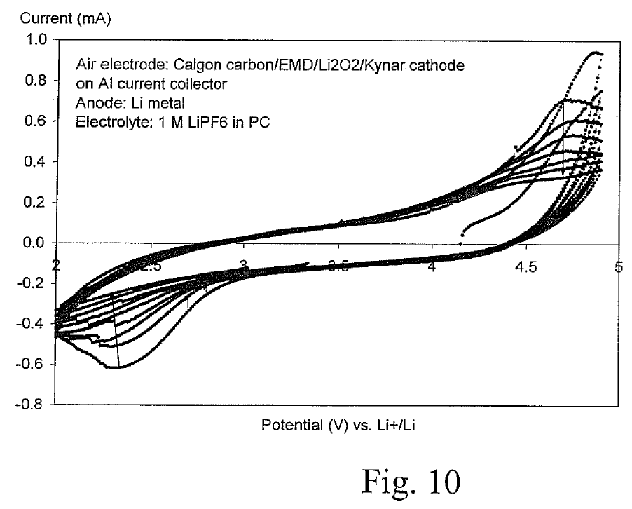

To identify the charging mechanism and source of capacity fade in a Li/O₂ cell, cyclic voltammetry has been used to investigate the Li₂O₂ decomposition, and oxygen reduction during charge and discharge processes. The cell used a lithium foil anode, a Li₂O₂ containing cathode (with Al current collector) and 1 M LiPF₆ in PC:DME (1:2 by wt.) as electrolyte. The cyclic voltammogram curves are shown in FIG. 10. The sample was cycled between 2 and 4.9 V with a scan rate of 0.1 mV/s. A clear cathodic peak, corresponding to the reduction of oxygen in the aprotic electrolyte has been identified at ˜2.7 V vs. Li⁺/Li and this peak moved to ˜2.5 V with increasing cycle number. The current of the cathodic, oxygen peak decreases with increased number of cycles; this decreased peak is directly related to the cycle fade in the Li/O₂ cell. Although it is not very clear during the first two charge cycles, an anodic peak at ˜4.6 V starts to appear during the third cycle. It is interesting to note that the decreasing peak values during the discharge cycles coincide with the decreasing peak values during the charge cycles. Both phenomena are also consistent with the capacity fade of the cell.

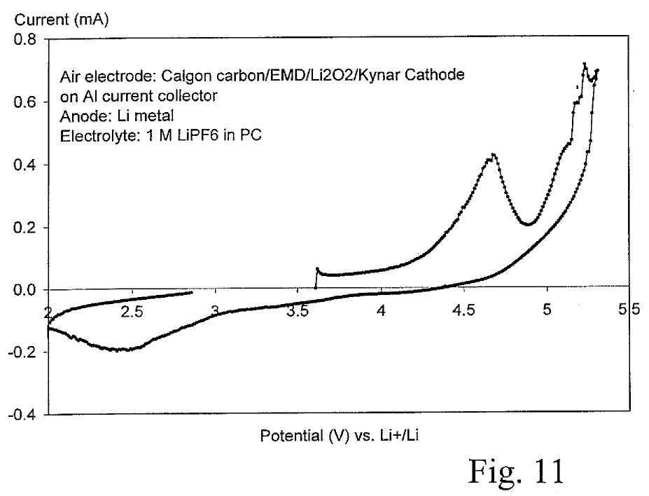

Another Li/O₂ cell with the exactly same structure as those shown in FIG. 11 has been cycled at a much slower rate (0.01 mV/s). The cyclic voltammetry data of this sample is shown in FIG. 11. The anodic current started to increase from ˜4.2 V and peaked at 4.68 V, then started to decrease until 4.9V. The clear peak at ˜4.6 V can be identified as the decomposition of the lithium peroxide. The monotonic increase of anodic current after 4.9 V can be attributed to the decomposition of electrolyte. The cyclic voltammetry data shown in this section has successfully confirmed that the charge/discharge capacity shown in the cycling data of Li/O₂ cells process (see previous sections) is directly related to a reversible electrochemical process, not to the decomposition of electrolyte.

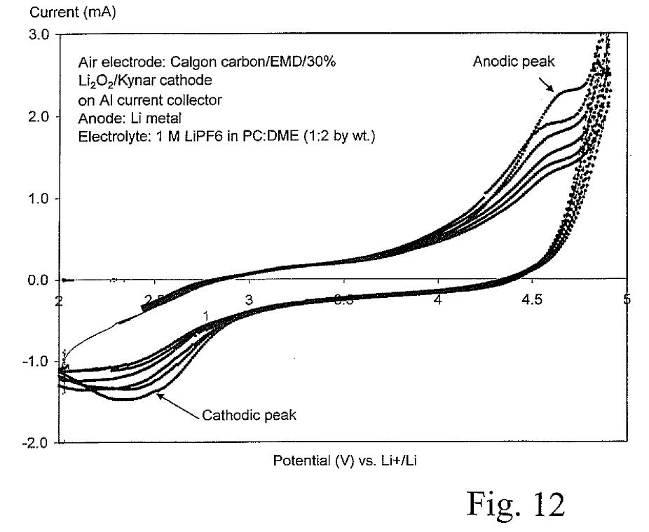

A similar test was conducted for a cathode containing 30% Li₂O₂ to see if the anodic peak may be greater than the one observed in previous experiments which used 14% Li₂O₂. The cell has a composition of the following: Calgon carbon (57%), Li₂O₂ (30%), Electrolytic MnO₂ (EMD) (2%), Kynar (10%), and carbon black (3%). Al mesh was used as the current collector; Li anode; 1 M LiPF6 in PC:DME (1:2) was used as the electrolyte. The cyclic voltammetry data of the cell (cv0212a.044) is shown in FIG. 10. The sample was cycled in 1 M LiPF₆ in PC:DME (1:2) at a rate of 0.1 mV/s. Comparing the cyclic voltammetry data shown in FIG. 10 and FIG. 12, anodic peak (at ˜4.6V) in the sample contain 30% Li₂O₂ (see FIG. 12) is similar to those observed in the case of 14% Li₂O₂ cathodes (see FIG. 10). This observation is the further evidence that the anodic peaks at ˜4.6 V corresponding to the decomposition of Li₂O₂.

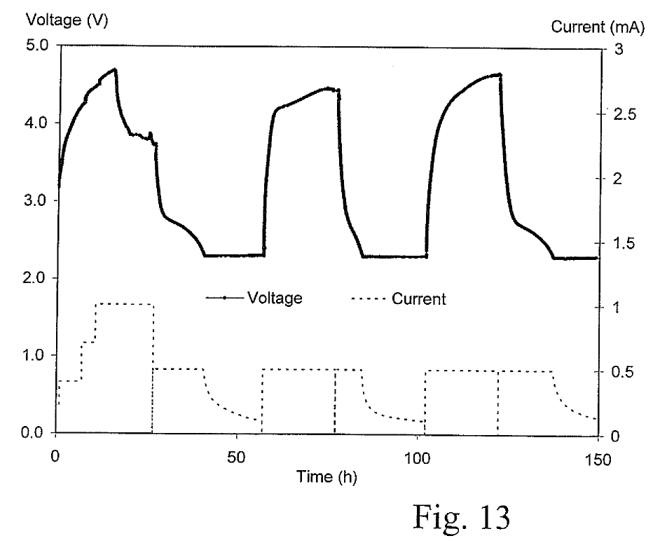

Since anodic peaks at 4.6 V (which is assumed to be related to decomposition of Li₂O₂) were found in cells that used either PC:DME or PC based electrolytes, cells were set up for charge/discharge cycling between 4.8 and 2.3 V. Further examination of the test results show that significant current or voltage noise were found during the initial stage of the charging process. Therefore, a “formation” process has been introduced at the beginning of the charge cycle to stabilize the samples. A stepwise current profile was used during the first charging process to facilitate the formation of possible solid electrolyte interface on the carbon electrolyte. This formation process has been proved to be very useful in noise reduction. The results from a Li/O₂ cells with a cathode containing 14% Li₂O₂ and cycled in 1 M LiPF₆ in PC:DME (1:2) are shown FIG. 13. During the initial cycle, cell voltage started to drop when it reach 4.65V. This may related to the exhaustion of Li₂O₂ pre-mixed in the electrode. Further current flow after all of Li₂O₂ was decomposed may related to the decomposition of electrolyte or current collector corrosion.

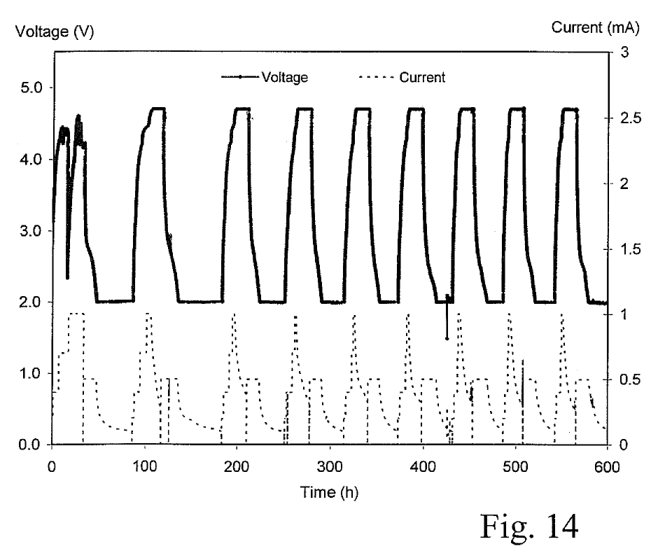

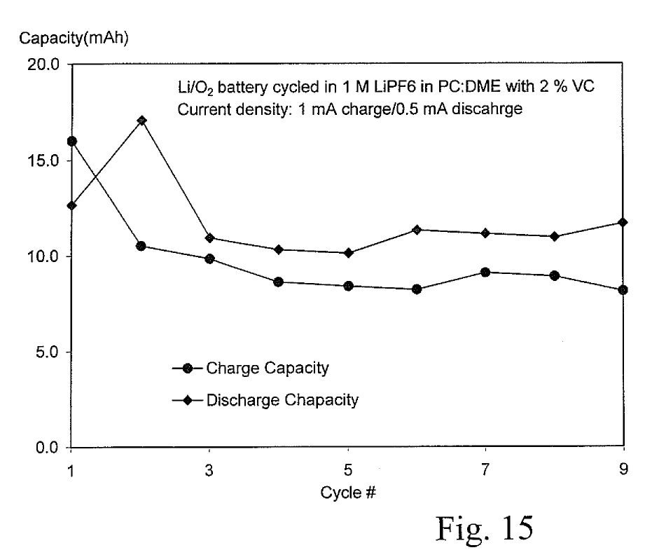

The initial voltage drop shown in FIG. 11 may related to the decomposition of electrolyte or corrosion of current collectors. FIGS. 14 and 15 shows the voltage/current profiles and cycling behavior of a Li/O₂ cell, respectively, that includes vinylene carbonate as an electrolyte additive. The sample was tested in an electrolyte with Vinylene carbonate additive (1 M LiPF₆ in PC:DME with 2% Vinylene carbonate). Sample cathode has 14% of Li₂O₂. The cell voltage showed a dip in the voltage at constant current charging in the first cycle itself, and the cell did not charge to >4.4 V. This may be related to the formation of a solid electrolyte interface during the first cycle. The cell exhibited good discharge profile, and capacity, and the second charge cycle did not exhibit any noise.

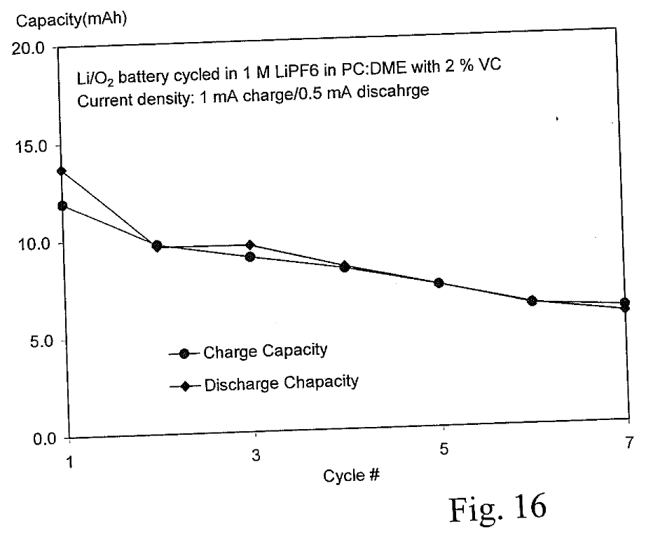

FIG. 16 shows the cycling stability of another Li/O₂ cell (La0417b.042) cycled in an electrolyte with Vinylene carbonate additive (1 M LiPF₆ in PC:DME with 2% Vinylene carbonate). Sample cathode has 14% of Li₂O₂. An Al rod was used to connect cathode current collector to the outside of the cell. Excellent Coulomb efficiency has been observed on this sample.

FIG. 16 Cycling stability of another Li/O₂ cell (La0417b.042) tested in an electrolyte with Vinylene carbonate additive (1 M LiPF₆ in PC:DME with 2% Vinylene carbonate). Sample cathode has 14% of Li₂O₂. Al rod was used to connect cathode current collector to the outside of the cell.

Most of previous tests have used conventional CCCV (constant current followed by constant voltage) procedures to test Li/O₂ batteries. While there was significant improvement in the cycle life by increasing the voltage limit for charging, the charging profiles were always plagued with noise, especially in the voltage, during constant current charging, and sometimes in the current during constant voltage charging at the voltage limit. Attempts at eliminating this noise by changing the electrolytes and current collectors, and applying surface treatments to current collectors resulted in mixed successes.

Recently, a different charging procedure has been adopted for the Lithium-oxygen batteries. The new charging process relies on an initial stage of constant current charging, however, charging is terminated when the battery voltage drops by a value specified in the charging routine (typically 20-50 mV). This charging procedure, also referred to as a “negative ΔV” charge control procedure, is widely used in Nickel-Cadmium and Nickel-Metal Hydride batteries, and allows termination of charge when the battery voltage drops after reaching a peak voltage. In the case of the Lithium-oxygen battery, the drop in the voltage is believed to occur due to the completion of decomposition of Li₂O₂. In fact, there is a good agreement between the values of charge required for the negative ΔV event on the first charge process, and the theoretical value of charge required to decompose the Li₂O₂ loaded in the cathode. In addition to the negative ΔV method of charge termination, a voltage limit of 4.7 V has been included in the charging algorithm, and a second criterion of time has been included to terminate charge, if the battery switches to constant voltage charging, after reaching the voltage limit. In the future, a more elegant control, based on the electrochemical signature of the completion of Li₂O₂ decomposition may be used.

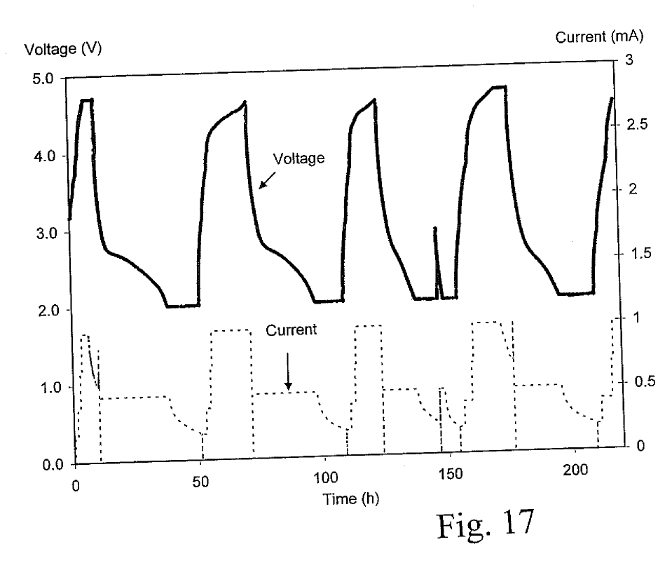

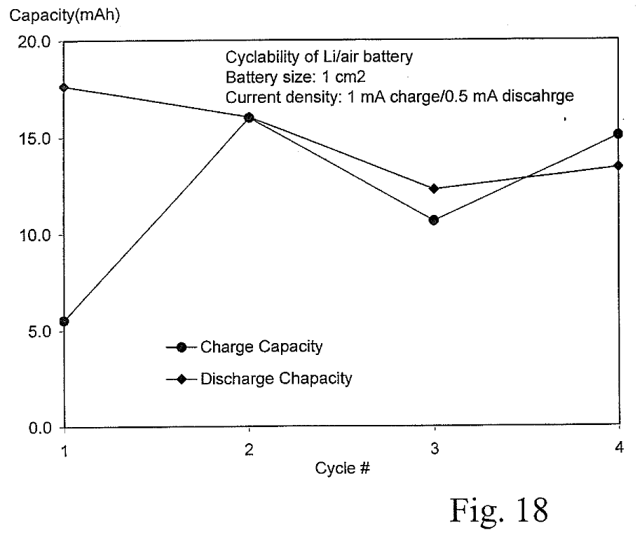

For the Lithium-oxygen battery, the use of a negative ΔV method of charge control/termination seems to be more appropriate than a CCCV process, because upon charging, unlike in a traditional Li-ion battery, the decomposition products, Li and oxygen gas do not remain in the cathode to sustain the high charging voltage; in contrast, in a Li-ion battery, the Li⁺ depleted, transition metal oxide cathode is capable of holding the voltage employed to charge the battery. The current and voltage profiles from a Lithium-oxygen battery (La0430a.044) that was subjected to charge-discharge cycling for four cycles using a negative ΔV charge termination are shown in FIG. 17. Sample cathode has 14% of Li₂O₂ and was cycled in 1 M LiPF₆ in PC:DME (1:2 by wt.) with 2% Vinylene carbonate additive. The spikes in the third cycle is due to power disruption. Cycle capacity of the cell is plotted as a function of cycle number in FIG. 18.

Remarkably, the charging profiles, voltage and current, are free of noise in the first four cycles. Based on impedance characteristics of the cathode, charge termination may occur at different voltages in different cycles; this issue is currently under investigation. In general, with increase in the number of cycles, due to an apparent increase in the cathode impedance, the charge termination occurs at higher voltages, or the charging voltage reaches the limit set by the algorithm (4.7 V in the above example), and undergoes charging at constant voltage until current is reduced to specified cut off value.

Based on these tests, some basic conclusions may be apparent: (1) Charging to higher voltages (>4.6 V) is necessary to fully charge the cell by decomposing Li₂O₂. When cells were charged to these higher voltages, the capacity fade in discharge was minimized relative to the cases where the cells were only charged to 4.3 V or less. (2) Cells need to be subjected to a ‘formation’ process to allow a slow charge initially. In fact, a slow charge may be necessary in subsequent steps also, since charging at higher rates (1 mA/cm²) seems to cause severe noise in both current and voltage profiles. (3) Negative delta V charging process is effective in reducing the noise in voltage/current profiles which may related to the side effect in Li/O₂ batteries.

Feasibility of a rechargeable lithium/oxygen battery with no lithium or oxygen in the original battery structure has been investigated. Both lithium and oxygen will be released during the initial charging process from Li₂O₂ pre-mixed in cathode. Lithium anode will be deposited on copper current collector during this formation process. If feasible, this rechargeable lithium/oxygen battery will further improve the specific energy of the Li/O₂ battery. A Lithium metal-free Li/O₂ battery was prepared for use in blue bag cells.

In a rechargeable lithium/oxygen battery with no lithium, nor oxygen in the original battery structure. Both lithium and oxygen will be released during the initial charging process from Li₂O₂ pre-mixed in cathode. This rechargeable lithium/oxygen battery will be self-sustainable in a closed environment; therefore the problems associated with lithium corrosion when exposed to air/moisture can be eliminated.

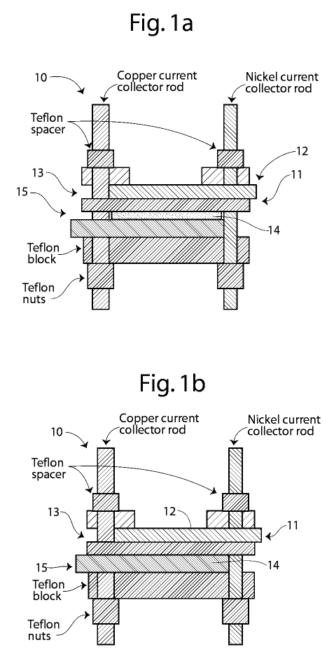

Feasibility of a rechargeable lithium/oxygen battery with no lithium or oxygen in the original battery structure has been investigated. Both lithium and oxygen will be released during the initial charging process from Li₂O₂ pre-mixed in cathode. Lithium will be deposited on copper current collector during this formation process (for the cells with a structure shown in FIG. 1(b)) or intercalate into graphite (or soft carbon) electrode (for the cells with a structure shown in FIG. 1(c)).

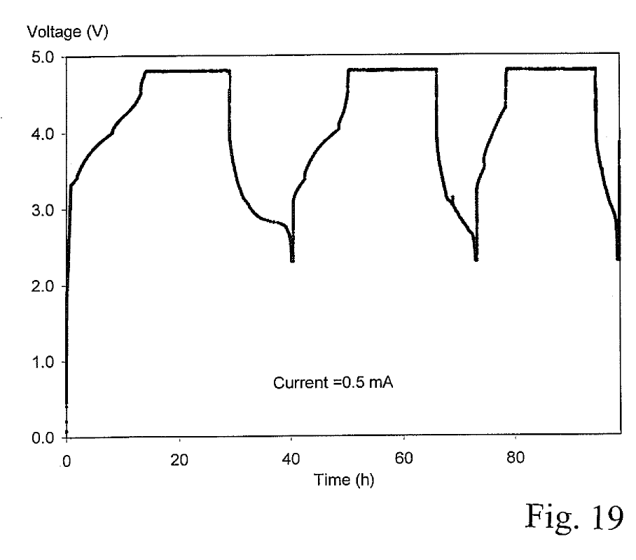

A Lithium metal-free Li/O₂ battery was prepared for use in polymer/metal lamination bag. A plain copper foil, which is to be used as the anode current collector, was laminated between two identical cathode layers made of the initial carbon layers. The results from tests are shown in FIG. 19. It shows that the Li-free cells function quite well for the first a few cycles. The discharge profiles show very good shapes, consistent with the battery operation, and the impedance of the cells seems to be low.

Significant progress has been made during the last quarter, on both the reversibility and discharge capacity of Li/O₂ cells. A Li/O₂ cell with a Li₂O₂ containing carbon cathode and lithium metal anode have been cycled in 1 M LiPF₆ in PC:DME (1:2) for more than 13 cycles with a capacity fade of ˜5.4%/cycle. The scale up procedures for assembling large pouch cells for Li/O₂ batteries have been developed. The feasibility of lithium-metal-free Li/O₂ battery was also investigated. Further development of this technology can lead to a high capacity Li/O₂ battery with significant reversibility which is suitable for military applications.

It should be understood that a typical reversible cathode contains ˜14% Li₂O₂, but the range from 0.5 to 50% are feasible. The battery capacity increases with increasing proportion of active carbon and porosity. Suitable cathode active material include: Calgon carbon (activated carbon), carbon black, metal powders such as Ni, activated carbon cloths, porous carbon fiber papers, metal foams. Suitable anodes includes: lithium metal, lithium metal based alloys (Li—Al, Li—Sn, Li—Si etc.), other lithium intercalating compounds used in Li-ion batteries such as graphite, MCMB carbon, soft carbon, Lithium titanate, etc. A cyclic voltammetry peak at ˜4.6 V is associated with decomposition of Li₂O₂. Charge to more then 4.6V will enhance the decomposition of Li₂O₂ Suitable Voltage range: 4 to 4.8 V for charging; 3-1.5 V for discharging. Increasing cycling voltage significantly increases the reversibility of the battery. PC based electrolyte (1 M LiPF₆ in PC:DME (1:2 in weight)) is the preferred electrolyte for rechargeable Li/O₂ batteries which can be charged to more than 4.3 V. Other suitable electrolyte include: 1 M LiPF6 in PC:THF (1:1), Other common electrolytes used for Li ion batteries consisting of the following solvents based on carbonates, esters, ethers, sulfones: Propylene carbonate, Ethylene carbonate, Dimethyl carbonate, Diethyl carbonate, Ethyl methyl carbonate, gamma-butyrolactone, sulfolane, 1,3-dioxolane, Tetrahydrofuran, Dimethoxyethane, Diglyme, Tetraglyme, Diethyl ether, 2-methyl tetrahydrofuran, tetrahydropyran, pyridine, N-methyl pyrrolidone, dimethyl sulfone, ethyl methyl sulfone, ethyl acetate, dimethyl formamide, dimethyl sulfoxide, acetonitrile, methyl formate. Electrolytes, for both the cathode and the separator, may be of the following lithium salts: LiPF6, LiBF4, LiAsF6, LiClO4, LIBOB, LiTFSI, LiTriflate, LiBr, and LiI, i.e., (lithium hexafluorophosphate, lithium tetrafluoroborate, lithium hexafluoroarsenate, lithium perchlorate, lithium bis(trifluorosulfonyl) imide, lithium triflate, lithium bis(oxalato) borate, lithium tris(pentafluoroethyl) trifluorophosphate, Lithium bromide, and lithium iodide). Preferably, the electrolyte contains a lithium intercalation compound. An alkylene carbonate, such as vinylene carbonate (Vinylene carbonate) or a butylene carbonate additive can improve the high voltage stability of electrolyte. Suitable Vinylene carbonate additive range: 0 to 10%. Suitable binders for carbon electrodes: Kynar, PTFE, Teflon AF, FEP etc. Suitable operating pressure: 0.5 to 100 Atm. Suitable operating pressure is between 0.5 to 100 Atm. It should be noted that a slow “formation” process and a “negative ΔV” charging process can increase the stability of the cell.

It should be understood that the term “air” as used herein is not intended to be limited to ambient air, and may include other combinations of gases containing oxygen or an amount of pure oxygen gas. This broad definition of the word “air” applies to all uses herein, including but not limited to air battery, air cathode, and air supply. It should be understood that the just described invention may include a battery that has not formed the anode yet, or include a battery which includes a preformed anode. When the battery does not yet include an anode, the anode is formed upon initial charging of the battery.

It thus is seen that a lithium-air battery is now provided that is manufactured in an simply process. It should of course be understood that many modifications may be made to the specific preferred embodiment described herein, in addition to those specifically recited herein, without departure from the spirit and scope of the invention as set forth in the following claims.

1. An air battery comprising:
an air cathode;
a separator loaded with an organic solvent based electrolyte including a lithium salt and an alkylene carbonate additive;
a cathode current collector;
an anode;
an anode current collector; and
a housing containing said cathode, said separator, said cathode current collectors said anode, said anode current collector, and a supply of air.

2. The air battery of claim 1 wherein said separator is a polymeric material.

3. The air battery of claim 2 wherein said separator is a porous polymeric material.

4. The air battery of claim 1 wherein said air cathode is loaded with an oxygen reduction catalyst.

5. The air battery of claim 4 wherein said oxygen reduction catalyst is selected from the group consisting of electrolytic manganese dioxide, ruthenium oxide, silver, platinum and iridium.

6. The air battery of claim 1 wherein said lithium salt is selected from the group consisting of lithium hexafluorophosphate, lithium tetrafluoroborate, lithium hexafluoroarsenate, lithium perchlorate, lithium bis(trifluorosulfonyl) imide, lithium triflate, lithium bis(oxalato) borate, lithium tris(pentafluoroethyl) trifluorophosphate, Lithium bromide, and lithium iodide.

7. The air battery of claim 1 wherein said alkylene carbonate additive is selected from the group consisting of vinylene carbonate and butylene carbonate.

8. The air battery of claim 4 wherein the concentration of oxygen reduction catalyst is between 1% and 30% by weight.

9. The air battery of claim 1 wherein said cathode is a carbon based air cathode containing a non-aqueous organic solvent based electrolyte including a lithium salt and an alkylene carbonate additive.

10. The air battery of claim 1 wherein said anode is selected from the group consisting of lithium metal, lithium metal based alloys, and lithium intercalation compounds.

11. The air battery of claim 1 wherein said anode is selected from the group consisting of graphite, MCMB graphite, soft carbon and lithium titanate.

12. An air battery cathode comprising porous carbon based air cathode containing a non-aqueous organic solvent based electrolyte including a lithium salt and an alkylene carbonate additive.

13. The air battery cathode of claim 12 wherein said alkylene carbonate additive is selected from the group consisting of vinylene carbonate and butylene carbonate.

14. The air battery cathode of claim 12 wherein said lithium salt is selected from the group consisting of lithium hexafluorophosphate, lithium tetrafluoroborate, lithium hexafluoroarsenate, lithium perchlorate, lithium bis(trifluorosulfonyl) imide, lithium triflate, lithium bis(oxalato) borate, lithium tris(pentafluoroethyl) trifluorophosphate, Lithium bromide, and lithium iodide.

15. The air battery cathode of claim 14 wherein said alkylene carbonate additive is selected from the group consisting of vinylene carbonate and butylene carbonate.

16. An air battery comprising:
an air cathode having a porous carbon based air cathode containing a non-aqueous organic solvent based electrolyte including a lithium salt and an alkylene carbonage additive;
a separator loaded with an organic solvent based electrolyte including a lithium salt and an alkylene carbonate additive;
a cathode current collector;
an anode;
an anode current collector; and
a housing containing said cathode, said separator, said cathode current collector, said anode, said anode current collector, and a supply of air.

17. The air battery of claim 16 wherein said separator is a polymeric material.

18. The air battery of claim 16 wherein said air cathode includes an oxygen reduction catalyst.

19. The air battery of claim 16 wherein said air cathode is loaded with an oxygen reduction catalyst.

20. The air battery of claim 19 wherein said oxygen reduction catalyst is selected from the group consisting of electrolytic manganese dioxide, ruthenium oxide, silver, platinum and iridium.

21. The air battery of claim 16 wherein said cathode lithium salt and said separator lithium salt are lithium hexafluorophosphate.

22. The air battery of claim 16 wherein said cathode lithium salt and said separator lithium salt are selected from the group consisting of lithium hexafluorophosphate, lithium tetrafluoroborate, lithium hexafluoroarsenate, lithium perchlorate, lithium bis(trifluorosulfonyl) imide, lithium triflate, lithium bis(oxalato) borate, lithium tris(pentafluoroethyl) trifluorophosphate, Lithium bromide, and lithium iodide.

23. The air battery of claim 16 wherein said cathode alkylene carbonate additive and said separator alkylene carbonate additive are selected from the group consisting of vinylene carbonate and butylene carbonate.

24. The air battery of claim 18 wherein said oxygen reduction catalyst is selected from the group consisting of electrolytic manganese dioxide, ruthenium oxide, silver, platinum and iridium.

25. The air battery of claim 16 wherein said anode is selected from the group consisting of lithium metal, lithium metal based alloys, and lithium intercalation compounds.

26. The air battery of claim 16 wherein said anode is selected from the group consisting of graphite, MCMB graphite, soft carbon and lithium titanate.
